(19) United States
(12) Patent Application Publication
(10) Pub. No.: US 2012/0166610 A1
(43) Pub. Date: Jun. 28, 2012

(54) METHOD AND SYSTEM FOR COMMUNICATION IN APPLICATION FIELD

(75) Inventors: Yoon Mee Doh, Daejeon (KR); Jong Arm Jun, Daejeon (KR); Cheol Sig Pyo, Daejeon (KR)

(73) Assignee: Electronics and Telecommunications Research Institute, Daejeon (KR)

(21) Appl. No.: 13/335,154

(22) Filed: Dec. 22, 2011

(30) Foreign Application Priority Data
Dec. 23, 2010 (KR) 10-2010-0133377

(51) Int. Cl. G06F 15/173

(52) U.S. Cl. 709/223

(57) ABSTRACT

The present invention relates to a method and system for communication in an application field that may communicate with a sensor or a computer incorporated in an object or an environment to collect information about an object or an environment associated with the object, or process the information to semantic information to be shared and provided to a user or the object, and may recognize and determine a surrounding circumstance independently and without a command from an external source, thereby providing an intended application service.

### CROSS-REFERENCE TO RELATED APPLICATION

This application claims the benefit of Korean Patent Application No. 10-2010-0133377, filed on Dec. 23, 2010, in the Korean Intellectual Property Office, the disclosure of which is incorporated herein by reference.

### BACKGROUND

1. Field of the Invention

The present invention relates to a method and system for communication in an application field that may communicate with a sensor or a computer incorporated in an object or an environment to collect information about an object or an environment associated with the object, or process the information to semantic information to be shared and provided to a user or the object, and may recognize and determine a surrounding circumstance independently and without a command from an external source, thereby providing an intended application service.

2. Description of the Related Art

Due to development of information technology by which users perform networking and use the Internet has brought about a paradigm shift towards an acceleration of nomadic computing, by changing human life based on mobile gadgets such as a smart phone, a personal digital assistant (PDA), and a portable multimedia device as well as a computer such as a personal computer and a laptop computer that may be possible to be used by anyone at any time and any location. In this respect, nomadic computing may be combined with a communication function to be used for various services by a smart phone that greatly affects human life. Currently, the paradigm shift is directed towards a service demand based on an organic communication exchange among a human, an object, and an environment.

In opposition to a conventional communication technology that has been based on human-to-human (H2H) communication since the invention of the telephone, a technology called Internet of Things (IoT) or Machine-to-Machine (M2M) communication is being realized to enable a sensor or a processing device incorporated in an object or an environment as well as humans to communicate with each other, as illustrated in FIG. 1 to show a new direction.

IoT or M2M communication is defined as intelligently performing devices that may communicate without a command from an external source, may recognize and determine a surrounding environment, and may deliver and exchange a determination result to and with to another homogeneous network such as a beyond 3G (B3G), a wireless personal area network (WPAN), and a wireless local area network (WLAN). Thus, an advent of a service using IoT or M2M communication such as a remote control of a mobile group is expected in a higher value-added business that provides various fusion application services such as an environment/disaster prevention/national defense linked business and a silver/disabled person welfare business, and the like, a medical industry such as an autonomous humanoid robot, and communication between vehicles.

A scheme of accessing IoT or M2M communication may have an aspect of “an extension of a sensor network,” that is, an extension of a technology based on an Ad-hoc network that does not define a predetermined infrastructure and an aspect of “an extension of mobile communication,” that is, an extension of a network based on an infrastructure. A standardization for IoT or M2M communication was started by International telecommunication union—telecommunication standardization sector (ITU-T) and European telecommunications standards institute (ETSI) several years ago, and a standardization for IoT or M2M communication in a next generation mobile communication field was started by machine type communications (MTC) of the 3rd generation partnership project (3GPP), smart embedded device (SED) by the 3rd generation partnership project 2 (3GPP2), and Institute of Electrical and Electronics Engineers (IEEE) 802.16m.

Information of an object is acquired in various aspects of human life. For example, commercialization of a radio frequency identification (RFID) used for distribution, a manufacturing business, a military defense, and the like is given. As an empirical example of ZigBee Alliance corresponding to a standardization for a sensor network in acquiring information about an environment installing and operating about twenty thousand Advanced Metering Infrastructure (AMI) meters of ZigBee Smart Energy 1.0 every week (OnCOR, Texas, the U.S.), installing and operating about 130 thousand nodes in the MGM City Center (Contrl4, the U.S.), and the like are given.

In particular, promotion of a Smart Grid Solution as a resolution for global warming is considered to be a trigger for IoT or M2M communication. In order to meet an rising global demand for technology responding to changes from closing of a conventional power network to opening of a Smart Grid, various vendors and electric power companies endeavor to construct interoperable smart energy infrastructures such as a smart meter, electronic appliances, and assets of an electric power company, which are characterized by securing interoperability of the Smart Grid by the National Institute of Standards and Technology (NIST), the International Organization for Standardization/International Electrotechnical Commission (ISO/IEC), ZigBee, the Internet Engineering Task Force (IETF), and the like.

IoT communication and M2M communication may be installed, in an object, a device capable of collecting information and communicating with another device, for example, an equipment and a machine, may collect information associated with the object or an environment, or process information into semantic information to be shared, and may provide information to a user or an object. Even though IoT communication and M2M communication may be superficially considered to be communication between objects and communication between a user device and an object, a machine, a condition of an object at a distance, an environment, and the like may be recognized. As various services in the Smart Grid solution may be provided as a result obtained through processing a large amount of information about an amount of energy consumption or data indicating an output that are collected by a remote device.

### SUMMARY

An aspect of the present invention provides a method and system for communication in an application field that may provide an application service by an interaction between a user device and a sensor or a processing device without an intervention of an application manager, as well as a service such as a management, a determination, and a provision of a to service by a service server or a communication corporation server connected to an Internet protocol (IP) network, in providing an application service based on an organic exchange of information among a sensor or processing devices that may be installed in an object or an environment in a configuration of various wired and wireless networks including a mobile communication network, a sensor network, a wireless local area network (WLAN), and the like.

According to an aspect of the present invention, there is provided a system for communication in an application field, the system including multiple sensor nodes to generate and transmit information of a detected event by detecting information of a recognized object, an actor node to activate an actor by determining control information from the information of a detected event transmitted from the multiple sensor nodes, and an access device to transmit, through an IP network, the information of a detected event received from the actor node to a service-providing server that processes a massive amount of information of a detected event.

According to another aspect of the present invention, there is provided a method for communication in an application field, the method including generating and transmitting information of a detected event by detecting information of a recognized object, activating an actor by determining control information from the transmitted information of a detected event, and transmitting, through an IP network, the information of a detected event received by the activated actor to a service-providing server that processes a massive amount of information of a detected event.

According to an embodiment of the present invention, it is possible to provide an application service excluding an intervention of a sensor network service server and support of a communication corporation server by directly providing a service used in an application field through direct or indirect interaction between a user device and a sensor or a processing device installed in an object, and it is possible to strengthen an advantage of Machine-to-to Machine (M2M) communication by distributing a process for a large amount of object information in a server to an actor node and a user device through peer-to-peer and M2M communication.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a conventional direction for development in Internet of Things (IoT) communication, which is referred to for describing an embodiment of the present invention;

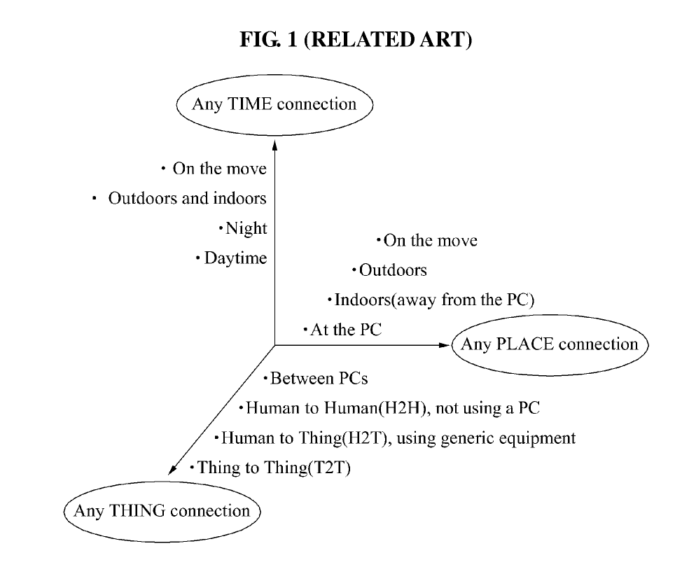

FIG. 2 is a diagram illustrating a network configuration for IoT communication that may be provided by a conventional sensor network according to a related art;

FIG. 3 is a diagram illustrating a network configuration for Machine-to Machine (M2M) communication that may be provided by a conventional mobile communication network according to a related art;

FIG. 4 is a diagram illustrating a basic network configuration for communication in an application field according to an embodiment of the present invention;

FIG. 5 is a diagram illustrating a network configuration for delivering information of an object using a user device in communication, in an application field according to an embodiment of the present invention;

FIG. 6 is a block diagram illustrating a configuration of an actor node and a user device for communication in an application field according to an embodiment of the present invention; and

FIG. 7 is a flowchart illustrating a sequence of a communication service in an application field according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

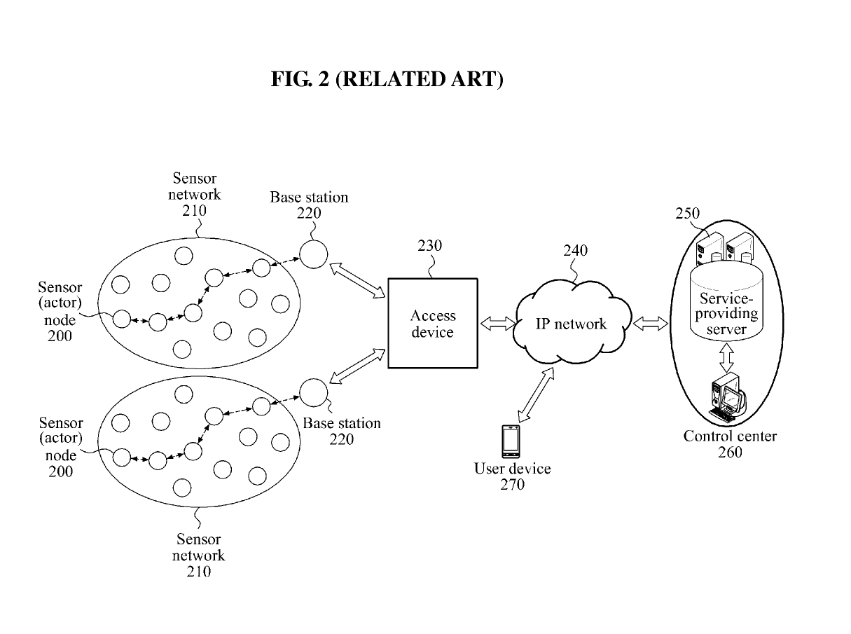

FIG. 2 is a diagram illustrating a network configuration for Internet of Things (IoT) communication that may be provided by a conventional sensor network according to a related art.

Description is directed to a network configuration for IoT communication associated with a sensor network 210. A network for IoT communication may include the sensor network 210, a base station 220, an access device 230, an Internet protocol (IP) network 240, a service-providing service 250, a control center 260, and a user device 270.

The sensor network 210 may include multiple sensor nodes 200 that generate and transmit information of a detected event by detecting information of a recognized object or information of recognized surrounding environment. Each of the multiple sensor nodes 200 may include a sensor to detect information of a recognized object and information of a recognized surrounding environment by recognizing a state of an object, a generator to generate information of a detected event by processing the detected information, and a transmitter to transmit the information of a detected event.

The base station 220 may receive the information of a detected event from the multiple sensor nodes 200 and relay the information to the access device 230. The base station 220 may include a receiver to receive the information of a detected event from the multiple sensor nodes 200 and a transmitter to process the received information of a detected event into a data packet to be transmitted to the access device 230.

The access device 230 may transmit, through the IP network 240, the information of a detected event received from the base station 220 to the service-providing server 250 that processes a massive amount of the information of a detected event. Here, the access device 230 may include a receiver to receive information of a detected event from the base station 220 associated with the sensor network 210 and a transmitter to transmit, through the IP network 240, the received information of a detected event to the service-providing server 250 that processes a massive amount of the information of a detected event.

The sensor network 210 and the base station 220 may be connected, through the access device 230 functioning as a gateway, to an IP network infrastructure such as the wired Internet, a wireless local area network (LAN), and satellite communication.

In a Machine-to Machine (M2M) network based on the sensor network 210, an information service of an object may be provided to a user or a manager controlling an operation. A result obtained by processing a massive amount of object information in the service-providing server 250 may be provided to the control center 260 or the user device 270. As an example, an application service may be provided through a private IP network instead of a public IP network according to an intention of the sensor network 210. Here, the user device 270 may not provide a service of acquiring or controlling sensor data since the conventional sensor network 210 has a structure in which the multiple sensor nodes 200 and the user device 270 may not directly communicate with each other.

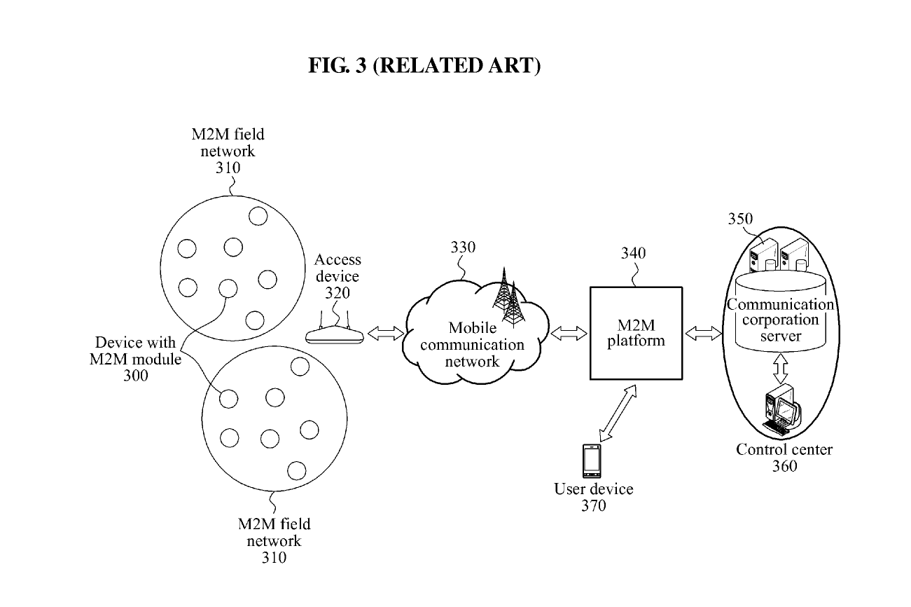

FIG. 3 is a diagram illustrating a network configuration for M2M communication that may be provided by a conventional mobile communication network according to a related art.

Description is directed to a network configuration for M2M communication that may be provided by a conventional mobile communication network.

A device with an M2M module 300 may include a sensor to detect information of a recognized object or environment, an actuator to operate a machine, and a mobile communication module to transmit the information and a result of the operated machine. The device with an M2M module 300 may use the sensor to collect information of a recognized object or environment information of an application field, operate the actuator to control an operation of the machine, and use the mobile communication module to transmit the information and the result of the operated machine to an M2M platform 340.

The device with an M2M module 300 included in an M2M field network 310 may deliver collected information to the M2M platform 340 through an access device 320 and a mobile communication network 330.

A communication corporation server 350 may generate semantic data by processing information collected in the M2M platform 340, and enable a control center 360 or a user device 370 to use the generated data.

When information of an environment in which an object is located is to be collected as defined by M2M communication, the M2M communication may not be suitable for acquiring and processing a large amount of information, and may be suitable for controlling equipment by a control command. Currently, a large number of leading telecommunication companies are attempting to construct a platform that is unique for telecommunication companies and for providing an M2M service including a control and a collection of information.

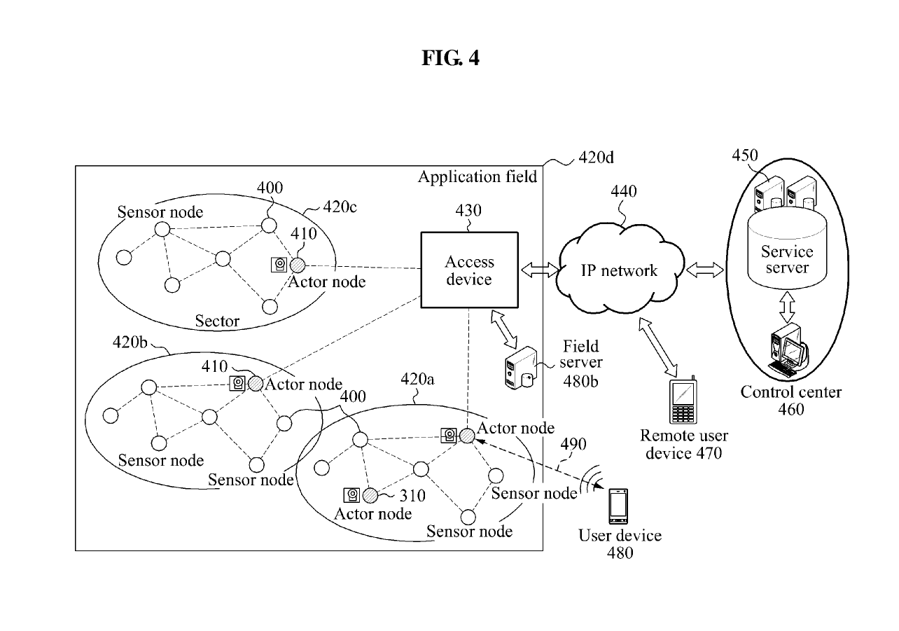

FIG. 4 is a diagram illustrating a basic network configuration for communication in an application field according to an embodiment of the present invention.

The description provided herein is directed to a basic network configuration for providing communication in an application field.

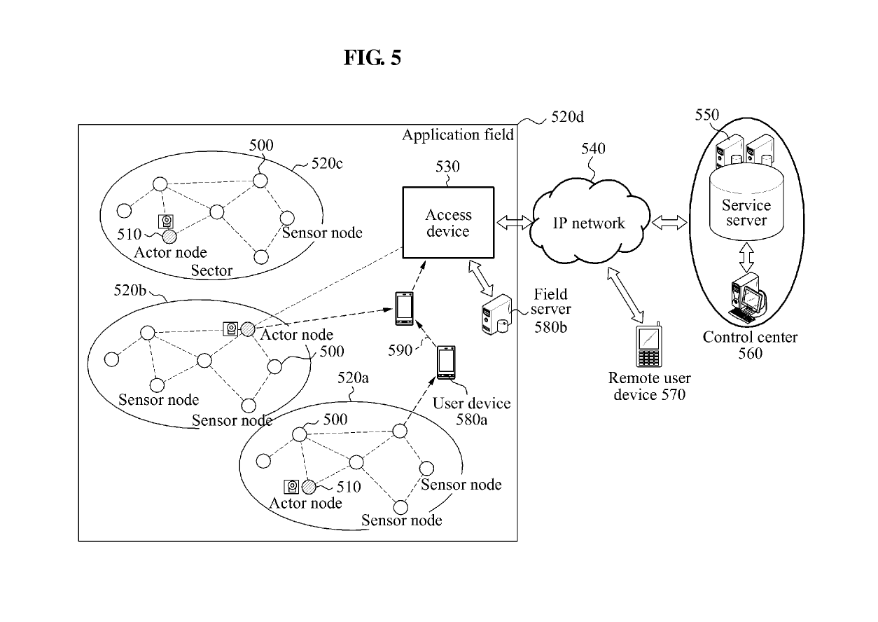

Even though a sensor node 400 may use a commercial power as a main power source, the sensor node 400 may operate based on a battery and use a small battery due to a characteristic of a sensor network. The sensor node 400 may detect, in real time, information of a recognized object or information of a recognized surrounding environment, and generate information of a detected event to be transmitted to an actor node 410. The sensor node 400 may generally operate based on a battery and use a small battery due to a characteristic of a sensor network, and may be installed in a device that uses a commercial power as a main power source. The sensor node 400 may detect, in real time, information of a recognized object or information of a recognized surrounding environment, and directly transmit the recognized information to the actor node 410 or generate information of a detected event to be transmitted to the actor node 410. Referring to FIG. 5, a sensor node capable of using a commercial power may function as an actor node, and directly communicate with a user device or an access device.

The actor node 410 may be installed in an actuator that controls a machine or equipment, and generally operates in an environment in which a commercial power source is provided and thus, may determine on a control command and on a sensor and information of a detected event received from the sensor node 400 included in a sector, irrespective of a power source, which may form an environment in which the actor node 410 may communicate with a user device 480. The environment may enable the actor node 410 to directly provide a control service desired by a user to the user device 480. The control service may be based on the actor node 410 constructed together with an equipment that may provide communication in an application field free from constraint of operation in comparison with the sensor node 400. The control service may be based on communication between the actor node 410 and a mobile terminal such as a cell phone, a smart phone, a laptop computer, and the like or the user device 480 of a wired and wireless terminal including an electronic device having a function of information communication.

An application field 420d may include multiple sectors 420a through 420c classified into physical or logic groups. Each sector may include multiple sensor nodes 400 and the actor node 410, and the actor node 410 may function as a leader of each sector. The actor node 410 may be managed and accessed by a field server 480b through an access device 430. Actor nodes may form a mesh network to access the access device 430. When the user device 480 arrives at the application field 420d, an agent of the user device 480 and the actor node 410 of a sector 420a may communicate depending on whether an application field service is provided. A mutual operation 490 between the actor node 410 and the agent of the user device 480 may enable the actor node 410 to provide, to the user device 480, a distributed service provided by the corresponding application field.

For example, a building used by a company may have sectors classified according to use, for example, a large and small conference room, an auditorium, a personal office, and the like. In a conference room freely constructed according to a purpose, when the actor node 410 is installed in equipment such as a lamp, a beam projector, and the like operating based on a commercial power source, the actor node 410 may provide a service, to the user device 480 accessing the actor node 410, informing that the conference room is being used. In response to a demand from a user, a configuration of the conference room and a state of use may be recognized by the field server 480b managing the actor node 410. The actor node 410 may generate condition information based on information of a predetermined sensor or information of multiple sensors in a sector formed as a group, and provide the condition information to the user device 480.

FIG. 5 is a diagram illustrating a network configuration for delivering information of an object using a user device 580a in communication in an application field 520d according to an embodiment of the present invention. The description provided herein is directed to a network configuration for delivering information of an object to the user device 580a by an actor node 510 or sensor nodes 500 in the application field 520d.

The sensor nodes 500 may operate based on a battery and use a small battery as a main power source. The sensor nodes 500 may deliver sensor information collected in sectors 520a, 520b, and 520c to a field server 580b through communication 590 between the user device 580a and another user device.

The sector 520a corresponds to a sensor network including sensor nodes 500, and the sector 520b corresponds to a sensor network including multiple sensor nodes 500 and an actor node. Here, the actor node functioning as a leader in the sector 520b may collect information of the multiple sensor nodes 500 in the sector 520b to be delivered to a field server 580b through the user device 580a.

A service server 550 may generate semantic data by processing information of a sensor network collected in the field server 580b, and enable a control center 560 or a remote user device 570 to use the generated data.

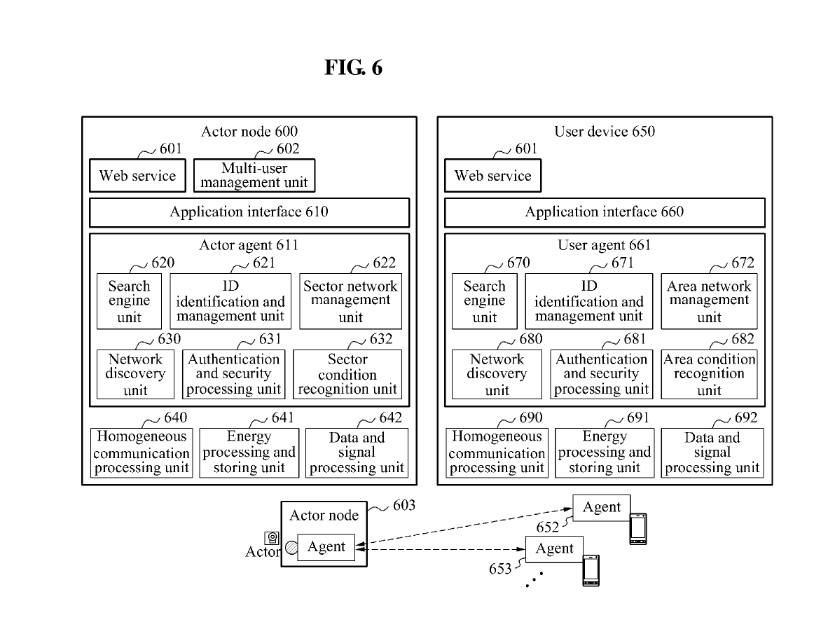

FIG. 6 is a block diagram illustrating a configuration of an actor node 600 and a user device 650 for communication in an application field according to an embodiment of the present invention.

A configuration of the actor node 600 and the user device 650 for communication in an application field is described with regard to a configuration in which two agents 652 and 653 are provided with an information service from an actor node 603.

The actor node 600 may include a web service 601, a multi-user management unit 602 configured to manage and control a provision of a service when the agents 652 and 653 request the service, an application interface 610, an actor agent 611, an homogeneous communication processing unit 640, an energy processing and storing unit 641, and a data and signal processing unit 642.

The actor agent 611 may include a search engine unit 620, an ID identification and management unit 621, a sector network management unit 622, a network discovery unit 630, an authentication and security processing unit 631, and a sector condition recognition unit 632.

In the actor agent 611, the search engine unit 620 may search for a service in a sector, the ID identification and management unit 621 may identify a user device, the sector network management unit 622 may manage a configuration of sensor nodes connected to each other in a sector, the network discovery unit 630 may search for a network service, the authentication and security processing unit 631 may process authentication and security of the user device, and the sector condition recognition unit 632 may determine a condition in a sector.

The homogeneous communication processing unit 640 may operate a communication module selected based on a type of a power supply, the energy processing and storing unit 641 may manage a power source, and the data and signal processing unit 642 may process data from information of a detected event collected from a sensor node.

The homogeneous communication processing unit 640 may support power line communication when operating based on a commercial power, and support communication such as a wireless personal area network (WPAN), a low-power wireless fidelity (Wi-Fi), and the like when operating on battery power.

The user device 650 may include a web service 651, an application interface 660, a user agent 661, a homogeneous communication processing unit 690, an energy processing and storing unit 691, and a data and signal processing unit 692.

The user agent 661 may include a search engine unit 670, an ID identification and management unit 671, an area network management unit 672, a network discovery unit 680, an authentication and security processing unit 681, and an area condition recognition unit 682.

In the user agent 661, the search engine unit 670 may search for a service in a sector, the ID identification and management unit 671 may identify an actor node, the area network management unit 672 may manage a network to deliver data between user devices, the network discovery unit 680 may search for a network service, the authentication and security processing unit 681 may process authentication and security of the actor node, and the area condition recognition unit 682 may determine a condition in a sector.

The homogeneous communication processing unit 690 may select one communication module among communication modules such as a WPAN, a low-power Wi-Fi, and the like, the energy processing and storing unit 691 may manage a power source, and the data and signal processing unit 692 may process data collected from multiple sectors connected to a user device.

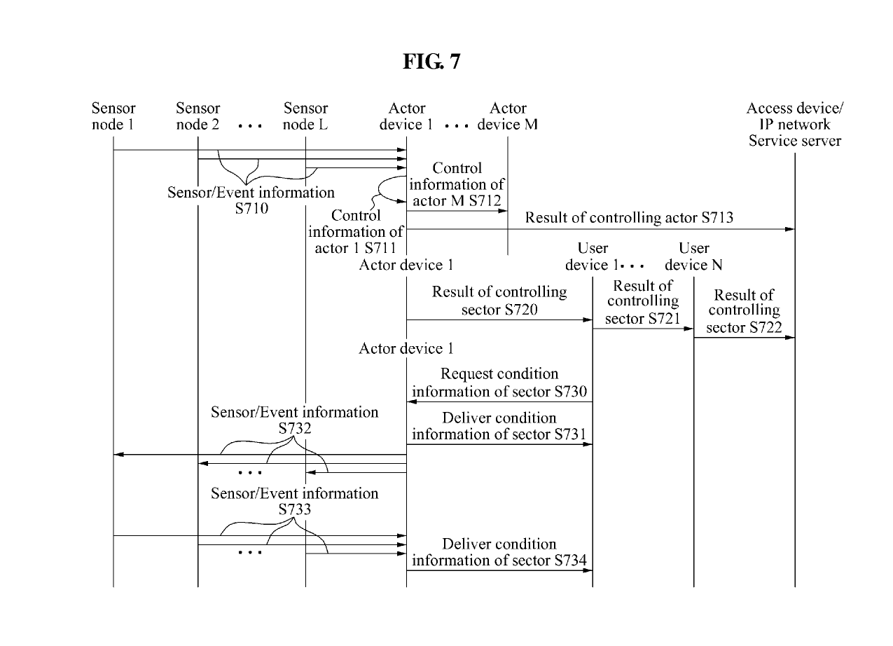

FIG. 7 is a flowchart illustrating a sequence of a communication service in an application field according to an embodiment of the present invention.

FIG. 7 illustrates an embodiment of a sequence of a communication service in an application field. For convenience of description, the description provided herein is directed to an example of a service sequence provided between N user devices and a service server by an application field sector including L sensor nodes and M actor devices.

In operation S710, sensor nodes (1 through L) may transmit sensor/event information to an actor device (1) functioning as a leader of a sector.

The actor device (1) may generate information for controlling an actor in the sector based on the sensor/event information received from a sensor node, and transmit control information to the actor device (1) in operation S711 and to an actor device requiring the control, for example, an actor device (M) in operation S712 so as to execute a control suitable for information of a recognized condition.

In operation S713, the actor device (1) may deliver a result of controlling an actor to a service server via an access device and an IP network based on a report of the result received from the actor device (M) or based on a determination of the actor device (1). A result of controlling a sector may be delivered to the service server in operation S722 via the access device and the IP network through communication with available user devices (1 through N) in operation S720 and operation S721.

When a user device (x), for example, a user device (1) among the user devices (1 through N) request condition information of a sector in operation S730, the actor device (1) may deliver, information obtained through management of a sensor node and actor devices in the sector in operation S731, or may request the sensor nodes (1 through L) for information of a sensor node in the sector in operation S732, acquire the information in operation S733, and deliver the information to the user device (1) in operation S734.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for communication in an application field, the system comprising:
multiple sensor nodes to generate and transmit information of a detected event by detecting information of a recognized object;
an actor node to activate an actor by determining control information from the information of a detected event transmitted from the multiple sensor nodes; and
an access device to transmit, through an Internet protocol (IP) network, the information of a detected event received from the actor node to a service-providing server that processes a massive amount of information of a detected event.

2. The system of claim 1, further comprising:
an actor node to function as a leader in a sector including the multiple sensor nodes and provide an information service to a user device accessing the sector; and
a field server to manage the actor node,
wherein the access device communicates with the actor node.

3. The system of claim 1, further comprising:
an actor node to function as a leader in a sector including the multiple sensor nodes;
a user device to receive the information of a detected event from the multiple sensor nodes and the actor node, and to relay the information to the access device; and
a field server to receive the information of a detected event from the user device through the access device.

4. The system of claim 2, wherein the actor node comprises:
an identifier (ID) identification and management unit to identify the user device;
an authentication and security processing unit to process authentication and security for the user device;
a search engine unit to search for a service in the sector;
a sector network management unit to manage a configuration of sensor nodes connected to each other within the sector;
a data and signal processing unit to process data from the information of a detected event collected from the multiple sensor nodes;
a sector condition recognition unit to determine a condition within the sector; and
a homogeneous communication processing unit to operate a communication module selected based on a type of a power supply.

5. The system of claim 2, wherein the user device comprises:
an identifier (ID) identification and management unit to identify an actor node;
an authentication and security processing unit to process authentication and security for the actor node;
a search engine unit to search for a service in the sector;
an area network management unit to manage a network to deliver data between user devices;
a data and signal processing unit to process data collected from multiple sectors connected to the user device;
an area condition recognition unit to determine a condition within the sector; and
a homogeneous communication processing unit to operate a selected communication module by incorporating a homogeneous communication module.

6. The system of claim 1, wherein the multiple sensor nodes comprise:
a sensor to detect information of a recognized object by recognizing a state of the object;
a generator to generate information of a detected event by processing the detected information; and
a transmitter to transmit the information of a detected event.

7. The system of claim 1, wherein the access device comprises:
a receiver to receive information of a detected event from a sensor node or an actor node of a sensor network, or from a base station; and
a transmitter to transmit the received information of a detected event to the service-providing service through the IP network.

8. The system of claim 1, further comprising:
a machine-to-machine (M2M) communication platform to communicate with the access device through a mobile network,
wherein the multiple sensor nodes transmit the information of a detected event to the M2M communication platform through the access device and the mobile network, by incorporating a communication module.

9. A method for communication in an application field, the method comprising:
generating and transmitting information of a detected event by detecting information of a recognized object;
activating an actor by determining control information from the transmitted information of a detected event; and
transmitting, through an Internet protocol (IP) network, the information of a detected event received by the activated actor to a service-providing server that processes a massive amount of information of a detected event.

10. The method of claim 9, further comprising:
forming an actor node that functions as a leader in a sector including multiple sensor nodes and provides an information service to a user device accessing the sector;
forming a field server that manages the actor node; and
enabling an access device to communicate with the actor node.

11. The method of claim 9, further comprising:
forming an actor node in a sector including the multiple sensor nodes;
receiving the information of a detected event from the multiple sensor nodes and the actor node, and relaying the information of a detected event to a user device; and
receiving the information of a detected event from the user device through an access device.

12. The method of claim 9, wherein the generating and transmitting comprises:
detecting information of a recognized object by recognizing a state of the object;
generating information of a detected event by processing the detected information; and
transmitting the information of the detected event.

13. The method of claim 9, wherein the generating and transmitting comprises:
receiving information of a detected event from multiple sensor nodes; and
processing the received information of the detected event into a data packet to be transmitted to an access device.

14. The method of claim 9, wherein the transmitting of the information of a detected event to a service-providing server comprises:
receiving information of a detected event from a base station associated with a sensor network; and
transmitting the received information of a detected event to a service-providing server through an IP network.

15. The method of claim 9, further comprising:
forming a machine-to-machine (M2M) communication platform that communicates with an access device through a mobile network,
wherein the generating and transmitting comprises transmitting the information of a detected event to the M2M communication platform through the access device and the mobile network.
